(19) United States
(12) Patent Application Publication
(10) Pub. No.: US 2025/0136019 A1
(43) Pub. Date: May 1, 2025

(54) INSERT UNIT FOR INSERTION INTO A STORAGE COMPARTMENT OF A CENTER CONSOLE

(71) Applicant: Ford Global Technologies, LLC, Dearborn, MI (US)

(72) Inventors: Friederike Philipsenburg, Canton, MI (US); Anja Neubert, Wermelskirchen (DE); Martin Erich Huebner, Bergisch Gladbach (DE); Robin Advena, Cologne (DE); Tim Klausmann, Heinsberg (DE); Marc Bisdorf, Cologne (DE); Bernd Ottlik, Pulheim (DE)

(73) Assignee: Ford Global Technologies, LLC, Dearborn, MI (US)

(21) Appl. No.: 18/908,971

(22) Filed: Oct. 8, 2024

(30) Foreign Application Priority Data
Oct. 25, 2023 (DE) 102023129459.8

(51) Int. Cl. B60R 11/02; B60R 11/00

(52) U.S. Cl. CPC B60R 11/0241; B60R 2011/0007

(57) ABSTRACT

An insert unit for insertion into a storage compartment of a center console of a vehicle, having a holding depression for at least partially receiving a portable electronic device such as a cell phone, and two holding portions, between which the holding depression is arranged and which define longitudinal sides of the holding depression. To provide an insert unit which is enhanced in terms of its capacity and its receiving properties, the holding portions each define a common holding plane against which an object can be placed flat, wherein the holding portions are designed in such a way that a spacing between the common holding plane and a planar base of the holding depression is greater than a height of the cell phone.

### CROSS-REFERENCE TO RELATED APPLICATION

This application claims foreign priority benefits under 35 U.S.C. § 119(a)-(d) to German Application No. 102023129459.8 filed Oct. 25, 2023, which is hereby incorporated by reference in its entirety.

### FIELD OF THE DISCLOSURE

The present disclosure generally relates to a device holder for holding a portable electronic device, and more particularly relates to an insert unit for insertion into a storage compartment of a center console of a vehicle having a holding depression for at least partially receiving a portable electronic device such as a cell phone.

### BACKGROUND OF THE DISCLOSURE

It is generally known to provide a center console of a vehicle with a storage compartment in the front of a media tray for receiving portable electronic devices such as cell phones. A media tray often contains a wireless charging module, which is concealed below a rubber mat inserted into the storage compartment. The rubber mat may be provided with ribs, which position an inductively chargeable cell phone, placed on the rubber mat, for optimum charging in a hot spot of the charging module. However, these conventional ribs typically prevent a further object, for example a second electronic device such as a second cell phone, a tablet, a notebook computer or the like, from being able to be properly accommodated in the storage compartment. Owing to the storage compartment generally being narrow and deep, small objects within the storage compartment are moreover usually difficult to pick up and to organize, particularly when an electronic device is in the optimum charging position on the rubber mat.

It would be desirable to provide for an insert unit for a storage compartment of a vehicle center console with enhanced capacity and receiving properties.

### SUMMARY OF THE DISCLOSURE

According to a first aspect of the present disclosure, an insert unit for insertion into a storage compartment of a center console of a vehicle has a holding depression for at least partially receiving an electronic device and two holding portions, between which the holding depression is arranged and which define longitudinal sides of the holding depression. The two holding portions each define a common holding plane against which an object can be placed substantially flat. The two holding portions are designed such that a spacing between the common holding plane and a planar base of the holding depression is greater than a height of the electronic device.

Embodiments of the first aspect of the present disclosure can include any one or a combination of the following features:
the electronic device comprises a cell phone;
the spacing between the common holding plane and the planar base of the holding depression is constant or decreases in a direction of a distal end region of the insert unit;
at least one holding projection extending in a transverse direction of one of the two holding portions and/or at least one holding recess extending in the transverse direction of the one of the two holding portions is/are formed on at least one holding portion;
a holding receptacle extending in a longitudinal direction of one of the two holding portions is formed on at least one of the two holding portions;
the holding receptacle is designed to hold a card or at least one coin or at least one pen or at least one remote control;
at least one holding receptacle extending in the longitudinal direction of a holding portion is formed on each of the two holding portions, and wherein the holding portions differ from one another in terms of a configuration of their respective holding receptacles;
at least one of the two holding portions extends over only part of a length of the holding depression;
at least one raised holding portion is arranged on a longitudinal edge of at least one of the two holding portions, which longitudinal edge is arranged at a spacing from the holding depression;
the insert mat is made at least partially of an elastomer; and
the insert unit is designed as an insert mat.

According to a second aspect of the present disclosure, a center console for a vehicle includes a storage compartment and an insert unit. The insert unit has a holding depression for at least partially receiving a portable electronic device and two holding portions, between which the holding depression is arranged and which define longitudinal sides of the holding depression. The two holding portions each define a common holding plane against which an object can be placed substantially flat. The two holding portions are designed such that a spacing between the common holding plane and a planar base of the holding depression is greater than a height of the portable electronic device.

Embodiments of the second aspect of the present disclosure can include any one or a combination of the following features:
the electronic device comprises a cell phone;
the spacing between the common holding plane and the planar base of the holding depression is constant or decreases in a direction of a distal end region of the insert unit;
at least one holding projection extending in a transverse direction of one of the two holding portions and/or at least one holding recess extending in the transverse direction of the one of the two holding portions is/are formed on at least one holding portion;
a holding receptacle extending in a longitudinal direction of one of the two holding portions is formed on at least one of the two holding portions;
the holding receptacle is designed to hold a card or at least one coin or at least one pen or at least one remote control, wherein at least one holding receptacle extending in the longitudinal direction of a holding portion is formed on each of the two holding portions, and wherein the two holding portions differ from one another in terms of a configuration of their respective holding receptacles;
at least one of the two holding portions extends over only part of a length of the holding depression;
at least one raised holding portion is arranged on a longitudinal edge of at least one of the two holding portions, which longitudinal edge is arranged at a spacing from the holding depression;
the insert mat is made at least partially of an elastomer, and wherein the insert unit is designed as an insert mat.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1A is a top schematic plan view of an exemplary embodiment for an insert unit according to one embodiment, which is arranged in a storage compartment of a center console of a vehicle;

FIG. 1B is a side schematic side view of the insert unit arranged in the storage compartment as shown in FIG. 1A with an object parallel to a cell phone;

FIG. 2A is a top schematic plan view of an insert unit arranged in a storage compartment of a center console of a vehicle with an object transverse to the cell phone;

FIG. 2B is a side schematic side view of the insert unit arranged in the storage compartment as shown in FIG. 2A;

FIG. 3A is a top schematic plan view of one embodiment of an insert unit arranged in a storage compartment of a center console of a vehicle with an object that can be placed in different positions;

FIG. 3B is a side schematic side view of the insert unit arranged in the storage compartment as shown in FIG. 3A;

FIG. 4A is a top schematic plan view of one embodiment of an insert unit arranged in a storage compartment of a center console of a vehicle with holding receptacles;

FIG. 4B is a side schematic side view of the insert unit arranged in the storage compartment as shown in FIG. 4A;

FIG. 5A is an upper perspective illustration of an insert unit according to one embodiment, which is arranged in a storage compartment of a center console;

FIG. 5B is an upper perspective illustration of the insert unit shown in FIG. 5A;

FIG. 5C is a schematic side view of the insert unit shown in FIGS. 5A and 5B; and

FIG. 5D is a perspective illustration of a portion of the insert unit shown in FIGS. 5A to 5C.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

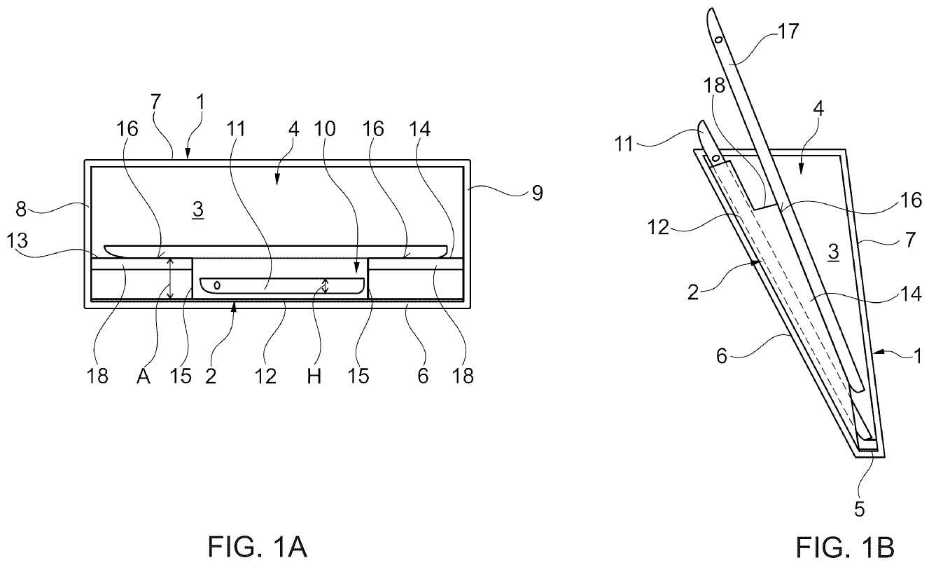

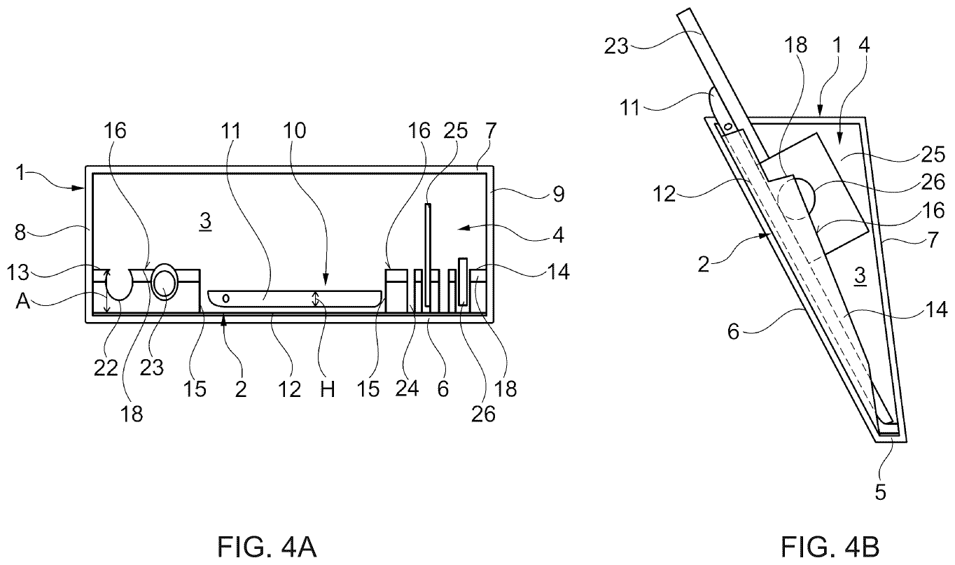

For purposes of description herein, the terms “upper,” “lower,” “right,” “left,” “rear,” “front,” “vertical,” “horizontal,” and derivatives thereof shall relate to the concepts as oriented in FIGS. 1A and 4B. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an insert unit for insertion into a storage compartment of a center console of a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The present application may refer to amounts and numbers. Unless expressly stated otherwise, such amounts and numbers should not be considered limiting but should be considered examples of the possible amounts or numbers in the context of the present application. In this context, the present application might also use the phrase “a plurality of” in order to refer to an amount or number. In this context, the phrase “a plurality of” should be in any number greater than one, e.g., two, three, four, five, etc. The terms “around”, “approximately”, “near”, etc. mean plus or minus 5% of the value specified.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

FIGS. 1A to 4A show a schematic plan view of an exemplary embodiment for an insert unit 2 according to one embodiment, which is inserted or arranged in a storage compartment 1 of a center console of a vehicle such as a motor vehicle. FIGS. 1B to 4B each show a schematic side view of the insert unit 2 shown in FIGS. 1A to 4A. The insert unit 2 may be made entirely or monolithically of an elastomer and may be designed in the manner of an insert mat.

As revealed from an overview of FIGS. 1A and 1B, 2A and 2B, 3A and 3B and 4A and 4B, a storage area 3 of the storage compartment 1 has a rectangular cross-sectional area, which tapers continuously or linearly from an upper access opening 4 of the storage compartment in the direction of a base 5 of the storage compartment 1. The storage compartment 1 has an inclined rear wall 6, a front wall 7, which is inclined in the same direction and more steeply, and two vertically aligned side walls 8 and 9. The shape of the storage compartment may also be described as a wedge shape, wherein a preferably flattened wedge tip forms a deepest point of the storage compartment 1.

The insert unit 2 has a central holding depression 10 for at least partially receiving a portable electronic device such as a cell phone 11. The holding depression 10 here has a planar base 12 on which the cell phone 11 lies. The holding depression 10 is preferably arranged in such a way that the planar base 12 of the holding depression 10 is arranged above an induction charging region (not shown) of the storage compartment 1 or the center console.

Moreover, the insert unit 2 has two holding portions 13 and 14, between which the holding depression 10 is arranged and which define the longitudinal sides 15 of the holding depression 10. The longitudinal sides 15 of the holding depression 10 are aligned perpendicularly to the planar base 12. A width of the holding depression, which lies in the drawing plane in FIGS. 1A, 2A, 3A and 4A, is greater than a width of the respective holding portion 13 or 14, which lies in the drawing plane of FIGS. 1A, 2A, 3A and 4A. The cell phone 11 may therefore be inserted lengthways into the holding depression 10.

The holding portions 13 and 14 each define a common holding plane 16 against which an object 17 is or can be placed flat. By way of example, the object is in the form of a tablet in the exemplary embodiment shown in FIG. 1. In particular, FIGS. 1B, 2B, 3B and 4B show that the holding plane 16 is arranged at an acute angle, i.e. inclined with respect to the planar base 12 of the holding depression 10, wherein the holding portions 13 and 14 in the drawing plane of FIGS. 1B to 4B taper in the direction of the base 5. The object 17 is therefore arranged virtually parallel to the cell phone 11. The holding portions 13 and 14 are designed in such a way that a spacing A between the holding plane 16 and the planar base 12 of the holding depression 10 is greater than a height H of the cell phone 11 placed in the holding depression 10. The spacing A between the holding plane 16 and the planar base 12 of the holding depression 10 decreases continuously or linearly in the direction of a distal end region (shown in FIGS. 1B to 4B), i.e. the end region of the insert unit 2 which is inserted furthest or deepest into the storage compartment 1.

A holding projection 18 is formed on each holding portion 13 or 14, which holding projection extends in the transverse direction of the respective holding portion 13 or 14. To this end, the respective holding portion 13 or 14 initially has a constant height, which then increases abruptly to form the holding projection 18 and subsequently decreases continuously or linearly in the direction of the distal end region of the insert unit 2.

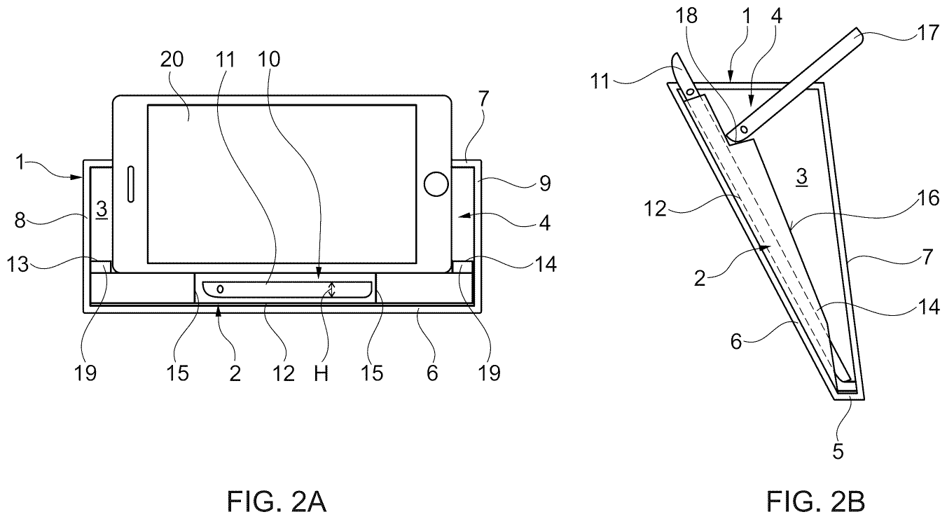

By way of example, the object 17 in the exemplary embodiment illustrated in FIGS. 2A and 2B is in the form of a further cell phone, which can be placed flat against the holding plane 16, wherein the object 17 can be placed against the holding plane 16 in particular transversely to the cell phone 11 lying on the planar base 12. As can be seen in FIGS. 2A and 2B, the object 17, i.e. the further cell phone, leans with a lower transverse edge (as seen in the drawing plane) against the holding projection 18, wherein, above this, the object 17 is supported against the front wall 7. To reduce the likelihood of rattling and unwanted contact with the object, an elastic front wall edge, for example a rubberized front wall edge, may be provided.

According to the exemplary embodiment illustrated in FIGS. 2A and 2B, the object 17 or the further cell phone is therefore positioned on the holding projections 18 of the holding portions 13 and 14. The object 17 moreover leans with its rear side against the front wall 7 of the storage compartment 1. As a result, due to the inclined position, the display 20 of the object 17 faces a person seated in the vehicle and is thus clearly visible.

A raised holding portion 19, which extends in the longitudinal direction of a respective holding portion 13 or 14 and by use of which the object 17 is secured on the insert unit 2 at its ends to prevent it from slipping, is arranged on a longitudinal edge of the respective holding portion 13 or 14, which longitudinal edge is arranged at a spacing from the holding depression 10. The spacing between the two raised holding portions 19 is adapted to a width of the transversely arranged object 17 and, by way of example, is about 160 to 170 mm so that the object is held in a correspondingly stable position. The positional stability may be enhanced if the holding projections 19 are adapted to a height of the object 17. Since the object 17, as illustrated, is a further cell phone, a height, i.e., an extent in the direction of the base 5, of approximately 7 to 9 mm may be ideal. The raised holding projections 19 may be designed to be resiliently flexible, i.e., to deflect upon contact with the object, i.e. with the edge regions thereof, and may generate or possess the necessary holding force. The raised holding projections 19 cannot be seen in FIG. 2B.

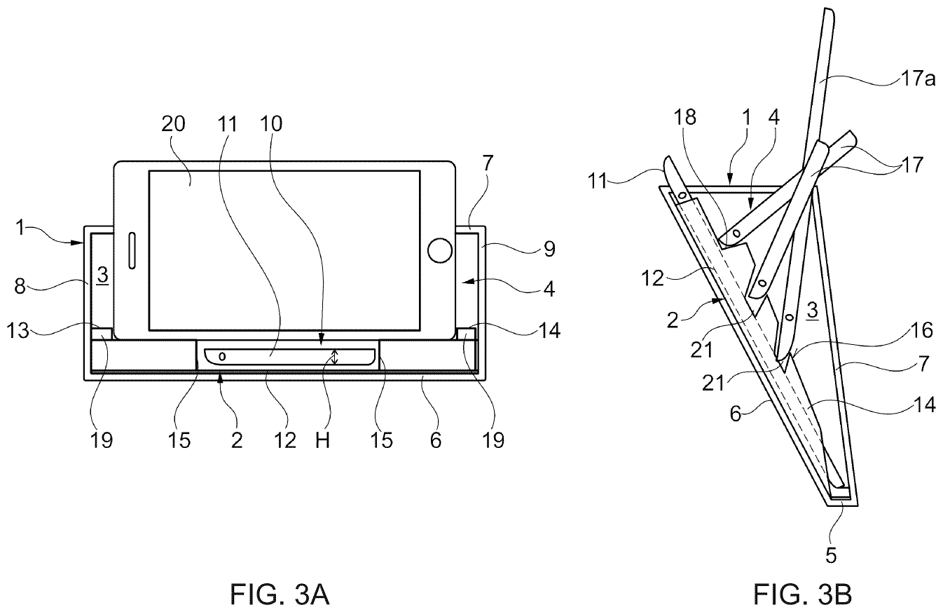

In the exemplary embodiment illustrated in FIGS. 3A and 3B, in addition to the holding projection 18, two holding recesses 21 are moreover formed on each holding portion 13 or 14, which holding recesses extend in the transverse direction of the respective holding portion 13 or 14 and are arranged on the respective holding portion 13 or 14 such they are spaced in a row in the direction of the base 5. As shown in particular in FIG. 3B, each holding recess 21 is aligned at an incline to the planar base 12 of the holding depression 10 in order to be accessible from above via the opening of the storage compartment 1.

The raised holding portion 19 (already described with reference to FIGS. 2A and 2B), which is provided in relation to the holding projection 18, which extends in the longitudinal direction of the respective holding portion 13 or 14 and by use of which the object 17 is secured on the insert unit 2 at its ends to prevent it from slipping, is moreover arranged on a longitudinal edge of the respective holding portion 13 or 14, which longitudinal edge is arranged at a spacing from the holding depression 10.

In the exemplary embodiment in FIGS. 3A and 3B, the object 17 or the further cell phone, is positioned on the holding projections 18 of the holding portions 13 and 14. The object 17 moreover leans with its rear side against the front wall 7 of the storage compartment 1. As described above, an elastic or rubberized front wall edge may be provided. As a result of the inclined position, the display 20 of the object 17 faces a person seated in the vehicle and is thus clearly visible. Moreover, in FIGS. 3A and 3B, a further position of the object 17 is shown, in which the object 17 engages in the upper holding recess 21 and leans with its rear side against the front wall 7 of the storage compartment 1. The object may therefore be arranged in the insert unit 2 or the storage compartment 1 in two different inclined positions, against the holding projection 18 on the one hand and against the upper recess 21 on the other. Moreover, in FIG. 3, a further object 17a is shown, which is in the form of a tablet and which engages in the lower holding recess 21 and leans with its rear side against the front wall 7 of the storage compartment 1. As a result, the display 20 (not shown) of the further object 17a faces a person seated in the vehicle and is thus clearly visible. Instead of the tablet, a further cell phone may also be positioned (in particular upright) in the lower holding recess 21 as seen in the drawing plane.

In the exemplary embodiment in FIGS. 3A and 3B, multiple positioning angles are advantageously possible, whereby the display 20 can also be easily seen in different light conditions or when different objects 17a, 17a are to be received by the insert unit.

In the exemplary embodiment illustrated in in FIGS. 4A and 4B, two holding receptacles 22 are formed on the holding portion 13, which holding receptacles extend in the longitudinal direction of the holding portion 13 and parallel to one another and are each designed for a pen 23 to be held or inserted therein. The holding receptacles 22 are designed to be circular in a manner adapted to the pen 23. Therefore, the pen 23 may be inserted into the holding receptacle 22 from the end face which is oriented towards the opening 4. It is possible to design the holding receptacle 22 with a slot which opens towards the holding plane 16 so that the pen can be pushed into the holding receptacle 22 from above.

According to the exemplary embodiment in FIGS. 4A and 4B, multiple, preferably four, holding receptacles 24 are formed on the holding portion 14, which holding receptacles extend in the longitudinal direction of the holding portion 14 and parallel to one another and are each designed to hold a card 25 or a coin 26 or a remote control (not shown). In this regard, the holding portions 13 and 14 differ structurally from one another in terms of the configuration of their respective holding receptacles 22 or 24.

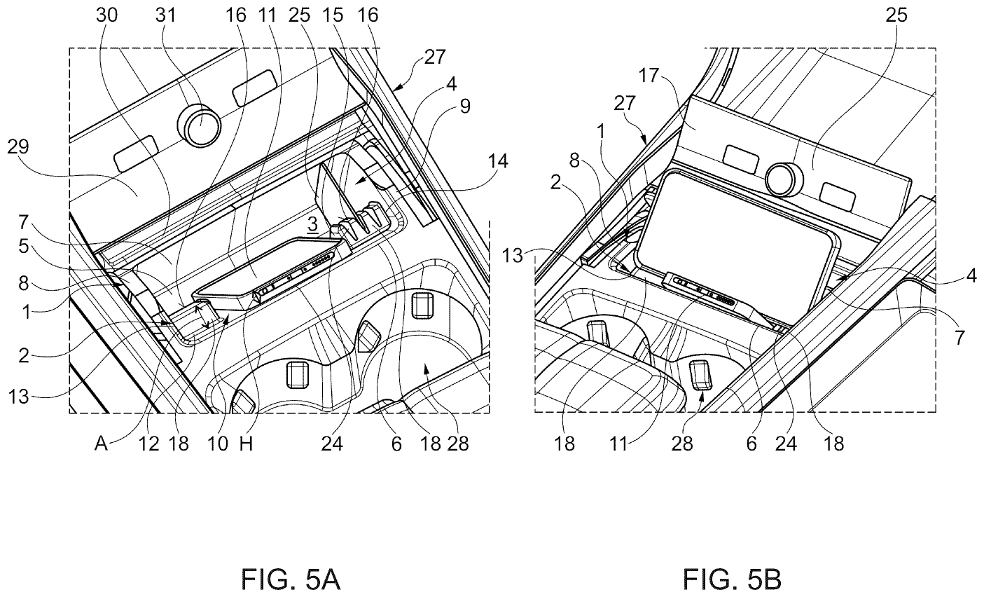

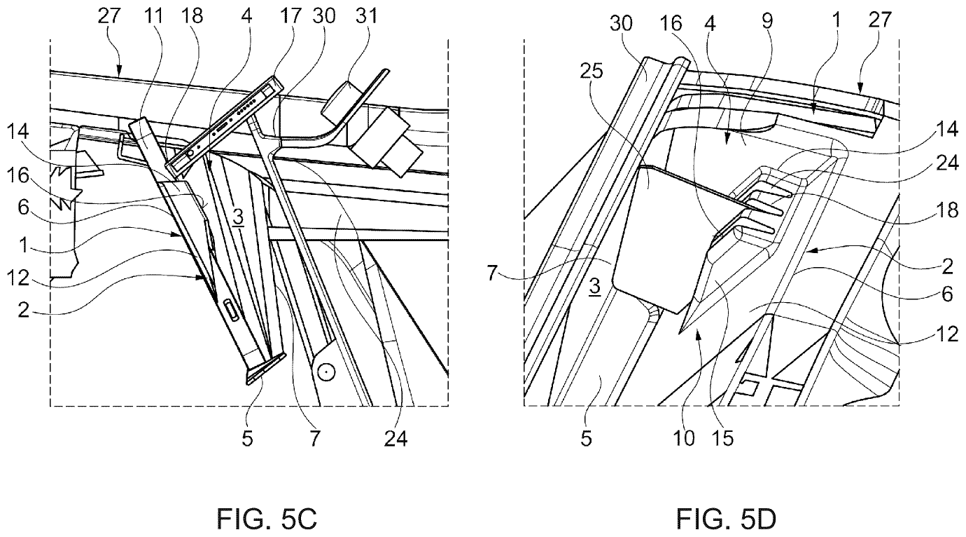

It goes without saying that the configurations of the insert unit 2 according to the exemplary embodiments in FIGS. 1A to 4B can be combined with one another. In FIGS. 5A to 5D, perspective views of details of the above-described exemplary embodiment in FIGS. 4A and 4B are also shown.

FIG. 5A shows a schematic and perspective illustration of an exemplary embodiment for an insert unit 2, which is inserted or arranged in a storage compartment 1 of a center console 27 of a vehicle (not shown). FIG. 5B shows a further schematic and perspective illustration of the insert unit 2 shown in FIG. 5A. FIG. 5C shows a schematic side view of the insert unit 2 shown in FIGS. 5A and 5B. FIG. 5D shows a further schematic and perspective illustration of a portion of the insert unit 2 shown in FIGS. 5A to 5C. The insert 2 may be made entirely or monolithically of an elastomer and may be designed in the manner of an insert mat. The storage compartment 1 is arranged with its front side facing a drink holder portion 28 of the center console 27.

As can be seen from an overview of FIGS. 5A to 5D, a storage area 3 of the storage compartment 1 has a rectangular cross-sectional area, which tapers continuously or linearly from an upper access opening 4 of the storage compartment 1 in the direction of a base 5 of the storage compartment 1. The storage compartment 1 here has an inclined rear wall 6, a front wall 7, which is inclined in the same direction and more steeply, and two vertically aligned side walls 8 and 9. The shape of the storage compartment may also be described as a wedge shape, wherein a preferably flattened wedge tip forms a deepest point of the storage compartment 1.

As illustrated in FIG. 5A, the storage area 3 has a screen 29. Moreover, a cover flap 30 can be seen, which, by way of example, swings over the compartment in a spring-loaded manner through push-push activation so that the storage area 3 can be closed as required. In this regard, the above-mentioned rubberized front wall edge may be expediently arranged on the cover flap 30. A multimedia controller 31, which is not connected to the cover flap 30c, can furthermore be seen.

The insert unit 2 has a central holding depression 10 for at least partially receiving a cell phone 11. The holding depression 10 here has a planar base 12 on which the cell phone 11 lies. The holding depression 10 is preferably arranged in such a way that the planar base 12 of the holding depression 10 is arranged above an induction charging region (not shown) of the storage compartment 1 or the center console.

Moreover, the insert unit 2 has two holding portions 13 and 14, between which the holding depression 10 is arranged and which define the longitudinal sides 15 of the holding depression 10. The longitudinal sides 15 of the holding depression 10 are aligned perpendicularly to the planar base 12. A width of the holding depression 10 is greater than a width of the respective holding portion 13 or 14. In particular, FIGS. 5C and 5D show that the respective holding portion 13 or 14 extends merely over part of a length of the holding depression 10. In the direction of a distal end region (shown in particular in FIGS. 5C and 5D), i.e. an end region of the insert unit 2 which is inserted furthest or deepest into the storage compartment 1, each holding portion 13 or 14 has an upper portion with a continuously increasing height, then a center portion with a constant height and then a lower portion with a continuously decreasing height. The upper portion may also be referred to as a holding projection 18. The center portion may also be referred to as a holding plane 16. The lower portion forms the tapering, material-saving end region of the respective holding portion 13 and/or 14.

The holding portions 13 and 14 each define a common holding plane 16 against which an object (not shown) can be placed flat. The holding portions 13 and 14 are designed in such a way that a spacing A between the holding plane 16 and the planar base 12 of the holding depression 10 is greater than a height H of the cell phone 11 placed in the holding depression 10. The spacing A between the holding plane 16 and the planar base 12 of the holding depression 10 is constant here and is defined by the center portion of the respective holding portion 13 or 14.

A holding projection 18 is formed on each holding portion 13 or 14, which holding projection extends in the transverse direction of the respective holding portion 13 or 14 and is formed by the upper portion of the respective holding portion 13 or 14.

Three holding receptacles 24 are formed on the holding portion 14, which holding receptacles extend in the longitudinal direction and parallel to one another and are each designed to hold a card 25 or a coin (not shown) or a remote control (not shown). In this regard, the holding portions 13 and 14 differ structurally from one another.

In FIG. 5A, the cell phone 11 is placed in the holding depression 10, as illustrated by way of example in FIG. 1, wherein a card 25 is received laterally in one of the holding receptacles 24. An object 17 in the form of a further cell phone is additionally present in FIG. 5B, which further cell phone is positioned on the holding projections 18 of the holding portions 13 and 14 and is arranged such that it extends transversely to the cell phone 11, as shown by way of example in FIGS. 2A and 2B. This is likewise shown in FIG. 5C, albeit from a different perspective. In FIG. 5D, neither the cell phone 11 nor the object 17 is arranged on the insert unit 2, with the holding portion 14 being shown in detail with a card 25 received therein.

It should be pointed out that the features and measures listed individually in the description may be combined with one another in any technically meaningful manner and demonstrate further configurations of the insert unit. The description additionally characterizes and specifies the insert unit in particular in conjunction with the drawing figures.

According to the present disclosure, the insert unit has two holding portions, each defining a common holding plane against which an object can be placed flat, wherein the two holding portions are designed in such a way that a spacing between the holding plane and a planar base of the holding depression is greater than a height of the cell phone. The insert unit according to the disclosure provides two holding planes, namely the lower holding plane, formed by the planar base of the holding depression, and the upper holding plane defined by the two holding portions. A cell phone can be placed flat against the lower holding plane, for example to also charge the cell phone wirelessly. An object, for example a further electronic device in the form of a further cell phone, a tablet or a notebook computer or a book, for example a notebook, can be placed flat against the upper holding plane. Since the spacing between the upper holding plane and the planar base of the holding depression or the lower holding plane is greater than a height of the cell phone placed flat against the lower holding plane, the cell phone placed flat against the lower holding plane and the object placed flat against the upper holding plane do not come into contact with one another. As a result, it is possible to reliably reduce the likelihood of unwanted contact with the cell phone and/or to the object and/or unwanted noises, in particular squeaking and rattling, which might arise due to contact between the cell phone placed flat against the lower holding plane and the object placed flat against the upper holding plane, in particular when a correspondingly equipped vehicle is moving.

The holding depression may be formed on the insert unit in such a way that a portable electronic device such as a cell phone placed in the holding depression is arranged above an induction charging region of the storage compartment or the center console in order to enable optimum charging thereof. The holding depression may be arranged approximately centrally on the insert unit. In an ideal configuration, the holding depression is adapted to the dimensions, in particular to the height, of the cell phone. If this cell phone has a height of e.g. 7 to 9 mm, for example, the depth of the holding depression may be 10 to 20 mm. A depth of the holding depression is therefore deliberately greater than a height of the cell phone. A length of the holding depression may correspond to a length of the cell phone or it may be greater or smaller than the length of the cell phone. The holding depression may have a substantially rectangular design. The longitudinal sides of the holding depression are defined by the holding portions of the insert unit. The holding depression may have an open or closed design at its transverse sides.

The two holding portions are designed as raised portions on the insert unit and receive the holding depression between them in that they define the longitudinal sides of the holding depression. The two holding portions may extend over the entire length of the holding depression or over part of this length along the holding depression. The contact surface, which is formed by the two holding portions and located in the upper holding plane, is interrupted by the holding depression. External dimensions of this contact surface are, however, significantly greater than external dimensions of the holding depression, for example in such a way that a further cell phone may be placed transversely to a longitudinal direction of the holding depression on the contact surface formed by the holding portions. Depending on the size of the contact surface formed by the holding portions, a portable electronic device such as a tablet, a notebook computer or a book, for example, may be placed thereon.

The insert unit according to the disclosure may be inserted into a storage compartment of a center console of a vehicle, which may have an induction charging region. In particular, mechanical fastening devices for fastening the insert unit in the storage compartment are not required. The dimensions of the insert unit may be adapted to the dimensions of a contact surface of the storage compartment on which the insert unit can be placed. The insert unit may be produced monolithically and may therefore be inserted into the storage compartment as a whole and without assembly effort.

The insert unit according to the disclosure is therefore enhanced in terms of its capacity and its receiving properties, especially since it is able to receive multiple electronic devices within a limited space such that they are not in unwanted contact with one another and are more easily accessible.

According to an advantageous configuration, the spacing between the holding plane and the planar base of the holding depression is constant or the spacing decreases in the direction of a distal end region of the insert unit. A distal end region of the insert unit is understood here to mean an end region of the insert unit which, in the conventional arrangement of the insert unit in a storage compartment of a center console, is arranged furthest away from a person, while a proximal end region of the insert unit is arranged closest to the person. If the spacing between the holding plane and the planar base of the holding depression decreases in the direction of a distal end region of the insert unit, an object in the form of an electronic device, book or the like, which is placed on the contact surface formed by the holding portions, is arranged at an acute angle to a cell phone located in the holding depression, which enhances the accessibility of the individual objects arranged on the insert unit, which, in this case, also includes the cell phone placed in the holding depression. In particular, if the spacing between the upper holding plane and the base of the holding depression is large enough, a constant spacing between the holding plane and the planar base of the holding depression may be selected since objects arranged on the two holding planes are spaced far enough away from one another to be easily accessible without needing to search for them.

According to a further advantageous configuration, at least one holding projection extending in the transverse direction of a holding portion and/or at least one holding recess extending in the transverse direction of a holding portion is/are formed on at least one holding portion. The holding projection or the holding recess thus also extends in the transverse direction of the holding depression. A further electronic device, a book, a street map or the like may be deposited on the holding projection or engage with its lower end portion in the holding recess and thus be positioned relatively upright so that it is easily visible and/or it can be easily picked up without any interaction with the cell phone located in the holding depression. This configuration therefore enables flexible positioning of further objects on the insert unit or on a correspondingly equipped storage compartment of a center console. Two or more such holding projections or holding recesses, arranged in a row and spaced from one another in relation to a longitudinal direction of the holding depression, may also be present on at least one holding portion in order to enable an object to be arranged at different heights and/or angles relative to the cell phone located in the holding depression. Both holding portions may also have a corresponding, in particular identical, design.

According to a further advantageous configuration, at least one holding receptacle extending in the longitudinal direction of the holding portion is formed on at least one holding portion. An object may be arranged on the holding receptacle so that it does not have to be placed loose in the storage compartment, which might lead to unwanted noises when a correspondingly equipped vehicle is moving and which might impede the accessibility of the object. Moreover, this reduces the likelihood of the object coming into unwanted contact with at least one electric device arranged on the insert unit, in particular a cell phone placed in the holding depression. The holding receptacle may be designed to receive an object in a form-fitting manner or to form a clamping seat between the holding portion and the object. The function of the holding receptacle may be enhanced if the holding portion, at least in the region of the holding receptacle, is made from an elastic material, which may deform elastically when the respective object is inserted.

According to a further advantageous configuration, the holding receptacle is designed to hold a card or at least one coin or at least one remote control or at least one pen. To hold a coin or a card, for example a bank card, access card or the like, or a remote control, for example for a garage door or barrier, the holding receptacle may be designed as a holding slot which extends parallel to the longitudinal direction of the holding depression. To hold a pen, the holding receptacle may be designed as a longitudinally open bore or the like, which extends parallel to the longitudinal direction of the holding depression.

According to a further advantageous configuration, at least one holding receptacle extending in the longitudinal direction of a holding portion is formed on each holding portion, wherein the holding portions differ from one another in terms of the design of their holding receptacles. As a result, objects of different designs may be arranged in the holding portions so that they are easily accessible, without having to be placed loose in the storage compartment.

According to a further advantageous configuration, at least one holding portion extends over merely part of a length of the holding depression. This is associated with a reduction in material and weight.

According to a further advantageous configuration, at least one raised holding portion is arranged on a longitudinal edge of at least one holding portion, which longitudinal edge is arranged at a spacing from the holding depression. As a result, an object placed on the upper holding plane or contact surface formed by the holding portions may be held laterally so that, when a correspondingly equipped vehicle is moving, the object does not slip back and forth on the contact surface and cause unwanted noises. A corresponding raised holding portion may also be arranged on each holding portion.

According to a further advantageous configuration, the insert unit is made at least partially of an elastomer. For example, the insert unit may be produced partially or entirely from rubber. As a result, a greater static friction is generated between the insert unit and an object arranged thereon, which means that an object may be arranged on the insert unit in a virtually slip-proof manner.

According to a further advantageous configuration, the insert unit is designed in the manner of an insert mat. The insert mat here is designed to be flexible or elastic, similarly to conventional rubber mats.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. An insert unit for insertion into a storage compartment of a center console of a vehicle, the insert unit comprising:
a holding depression for at least partially receiving an electronic device; and
two holding portions, between which the holding depression is arranged and which define longitudinal sides of the holding depression, wherein the two holding portions each define a common holding plane against which an object can be placed substantially flat, and wherein the two holding portions are designed such that a spacing between the common holding plane and a planar base of the holding depression is greater than a height of the electronic device.

2. The insert unit according to claim 1, wherein the electronic device comprises a cell phone.

3. The insert unit according to claim 1, wherein the spacing between the common holding plane and the planar base of the holding depression is constant or decreases in a direction of a distal end region of the insert unit.

4. The insert unit according to claim 1, wherein at least one holding projection extending in a transverse direction of one of the two holding portions and/or at least one holding recess extending in the transverse direction of the one of the two holding portions is/are formed on at least one holding portion.

5. The insert unit according to claim 1, wherein a holding receptacle extending in a longitudinal direction of one of the two holding portions is formed on at least one of the two holding portions.

6. The insert unit according to claim 5, wherein the holding receptacle is designed to hold a card or at least one coin or at least one pen or at least one remote control.

7. The insert unit according to claim 6, wherein at least one holding receptacle extending in the longitudinal direction of a holding portion is formed on each of the two holding portions, and wherein the two holding portions differ from one another in terms of a configuration of their respective holding receptacles.

8. The insert unit according to claim 1, wherein at least one of the two holding portions extends over only part of a length of the holding depression.

9. The insert unit according to claim 1, wherein at least one raised holding portion is arranged on a longitudinal edge of at least one of the two holding portions, which longitudinal edge is arranged at a spacing from the holding depression.

10. The insert unit according to claim 1, wherein the insert mat is made at least partially of an elastomer.

11. The insert unit according to claim 1, wherein the insert unit is designed as an insert mat.

12. A center console for a vehicle, the center console comprising:
a storage compartment; and
an insert unit comprising:
a holding depression for at least partially receiving a portable electronic device; and
two holding portions, between which the holding depression is arranged and which define longitudinal sides of the holding depression, wherein the two holding portions each define a common holding plane against which an object can be placed substantially flat, and wherein the two holding portions are designed such that a spacing between the common holding plane and a planar base of the holding depression is greater than a height of the portable electronic device.

13. The center console according to claim 12, wherein the portable electronic device comprises a cell phone.

14. The center console according to claim 12, wherein the spacing between the common holding plane and the planar base of the holding depression is constant or decreases in a direction of a distal end region of the insert unit.

15. The center console according to claim 12, wherein at least one holding projection extending in a transverse direction of one of the two holding portions and/or at least one holding recess extending in the transverse direction of the one of the two holding portions is/are formed on at least one holding portion.

16. The center console according to claim 12, wherein a holding receptacle extending in a longitudinal direction of one of the two holding portion is formed on at least one of the two holding portions.

17. The center console according to claim 16, wherein the holding receptacle is designed to hold a card or at least one coin or at least one pen or at least one remote control, wherein at least one holding receptacle extending in the longitudinal direction of a holding portion is formed on each of the two holding portions, and wherein the two holding portions differ from one another in terms of a configuration of their respective holding receptacles.

18. The center console according to claim 12, wherein at least one of the two holding portions extends over only part of a length of the holding depression.

19. The center console according to claim 12, wherein at least one raised holding portion is arranged on a longitudinal edge of at least one of the two holding portions, which longitudinal edge is arranged at a spacing from the holding depression.

20. The center console according to claim 12, wherein the insert mat is made at least partially of an elastomer, and wherein the insert unit is designed as an insert mat.
